(19) United States
(12) Patent Application Publication
(10) Pub. No.: US 2024/0213917 A1
(43) Pub. Date: Jun. 27, 2024

(54) WIND BREAK END PLATE FOR SOLAR PANEL ARRAYS

(71) Applicant: Gamechange Solar Corp., Norwalk, CT (US)

(72) Inventor: Scott Van Pelt, Tarrytown, NY (US)

(73) Assignee: Gamechange Solar Corp., Norwalk, CT (US)

(21) Appl. No.: 18/265,916

(22) PCT Filed: Dec. 8, 2021
(86) PCT No.: PCT/US2021/062359

§ 371 Date: Dec. 26, 2023

(51) Int. Cl. H02S 40/00; H02S 20/32

(52) U.S. Cl. CPC H02S 40/00; H02S 20/32

(57) ABSTRACT

A solar tracker arrangement is disclosed that includes a framework. a plurality of PV modules. a torsion tube and wind break plates. The framework is defined by running rails that extend in an east-west direction when the tracker is in an operational configuration, with the running rails spaced apart and parallel to each other. The PV modules are mounted to the running rails to define a PV module array. A torsion tube extends in a north-south direction when in an operational configuration, with the running rails secured to the torsion tube such that rotation of the torsion tube tilts the PV modules in the east-west direction. The wind break plates are mounted to the north and south edges of the PV module array and the torsion tube.

### BACKGROUND OF THE INVENTION

### 1. Technical Field

The present disclosure relates generally to solar tracker/racking arrangements and more specifically to an arrangement for reducing wind loads applied to solar modules in a solar panel array in the solar tracker arrangement.

### 2. Background Information

Use of solar tracking arrangements are on the rise as an environmentally friendly, clean energy source. Solar tracking arrangements include photo-voltaic (“PV”) modules arranged in a framework that are selectively moved or tilted to follow the sun's trajectory to maximize electrical generation capabilities of the system. Each PV or solar module includes a plurality of PV cells. In one exemplary arrangement, the framework is traditionally arranged in “1 Up” single axis solar tracker arrangement, where there is just one row of modules arranged on running rails that are supported on a north-south running torsion tube. The torsion tube is supported by bearings, for example, as shown in commonly owned U.S. Pat. No. 10,605,489, the contents of which are incorporated in its entirety, where the bearings are placed on fixed foundation elements. Using a motor arrangement, the solar tracker arrangement rotates the PV modules from east to west each day to follow the sun during the course of the day.

Alternatively, the framework may be arranged in a “2 Up” single axis solar tracker arrangement, where there are two rows of modules placed on each structure, one to the east of the torsion tube and one to the west, on either sides of the torsion tube. The 2 Up solar tracker arrangements allow for use of fewer foundation elements per PV module, thereby reducing installation costs, as well as larger row-to-row spacing, thereby facilitating more efficient operation and maintenance for the system. An example of a 2 Up solar tracker arrangement 10 is illustrated in FIG. 1. In these arrangements, the running rails 12 are elongated, as compared to the 1 Up solar tracker arrangement so as to be long enough to support the PV modules 14 on either side of the torsion tube 16.

To further increase the electrical generation capability, a growing trend in this industry is a move to providing “large format” PV modules. More specifically, traditional PV modules in the industry are approximately 1 m wide by 2 m tall. To maximize the investment in fixed costs, including real estate, reduce installation time (and cost) and improve electrical efficiency, PV module manufacturers have sought to construct larger modules, i.e., up to 1.3 m wide and 2.6 m tall. However, the structural design of single axis solar trackers is often governed by wind loads. The maximum wind loads occur at the edges of the PV module array where the wind loading the structure is laminar or semi-laminar. The PV modules on the edges of the array may break up the flow of the wind and “shelter” the modules on the interior of the array, but can also lead to damage of those sheltering modules. The gradient of the drop in wind pressure from the edge to the interior of the array has been well documented through boundary wind tunnel testing. For example, the pressure drops dramatically for points even 0.5× a chord length away from the north or south edges of the array.

Thus, increased surface area, i.e., large modules, can present a potential issue, particularly when mounted in the 2 UP configuration as the 2 UP configurations are more prone to aeroelastic instability, in particular vortex shedding. Indeed, the vortexes and therefore the associated pressures formed by a 2 Up single axis solar tracker are significantly larger than those formed by a 1 Up single axis solar tracker. This is a phenomenon where vortexes cyclically set up along the top tip of the modules causing the single axis trackers to rock back and forth repeatedly, potentially with very large deflections that could cause damage to the PV modules. Second, when at relatively steep tilt angles, 2-Up systems result in greater wind pressures on the PV-Modules than in 1-Up systems, particularly at the exposed North or South end of the tracker. Conventionally, longer steel mounting rails are provided with the tracker structure to mount the modules and provide more stability for them. However, due to the relatively low mechanical ratings of large format modules, even with the additional stiffness of these longer mounting rails, the mechanical capacity of the PV modules may be exceeded during the design wind event.

To maximize electrical generation capabilities of solar tracker/racking systems, as well as investment costs in such systems, what is needed is a system that allows for use of large format PV modules, but addresses potential failure issues caused by undesirable wind pressures on the ends (e.g., north and south ends) perpendicular to the longitudinal axis of the solar module array.

### SUMMARY OF THE DISCLOSURE

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

According to an aspect of the disclosure, a solar tracker arrangement comprises a framework defined by running rails that extend in a first direction when in an operational configuration, the running rails arranged to be spaced apart and parallel to each other; a plurality of PV modules mounted to the running rails to define a PV module array having a PV module cord length; a torsion tube extending in a second direction when in an operational configuration, the running rails secured to the torsion tube such that rotation of the torsion tube tilts the PV modules in the first direction where the first and second directions are substantially perpendicular, and a wind break plate mounted to both a proximate edge and a distal edge of the PV module array along the second direction and the torsion tube.

The wind break plate may include a perforated body section.

The wind break plate may further include one or more reinforcing members extending across the body section.

The PV module array may be arranged in a 2 UP configuration.

The wind break plate may include a chord length equal to the PV module array chord length.

According to another aspect of the disclosure, a solar racking arrangement comprises a framework defined by running rails that extend in an east-west direction when in an operational configuration, the running rails arranged to be spaced apart and parallel to each other; a plurality of PV modules mounted to the running rails to define a PV module array having a PV module cord length; a first wind break plate mounted to a north edge of the PV module array; and a first wind break plate mounted to a south edge of the PV module array.

The first and second wind break plates may each comprise a perforated body section.

The first and second wind break plates may comprise one or more reinforcing members extending across the perforated body section.

The PV module array may be arranged in a 2 UP configuration.

At least one of the first and second wind break plates may have a chord length equal to the PV module array chord length.

According to yet another aspect of the disclosure, a wind break plate comprises a body section bordered by support members; and at least one reinforcing member extending between a pair of the support members; wherein the body section includes a plurality of perforations therethrough.

The perforations may be formed in the range of 30% to 80% of a surface area of the body section.

The perforations may be spaced equidistance from each other.

The reinforcing members may extend longitudinally between parallel side edges of the body section.

The support members may have a thickness that is greater than the thickness of the body portion.

The reinforcing members may have a thickness greater than the support members.

### BRIEF DESCRIPTION OF THE DRAWINGS

FIG. 1 is a perspective view of a 2 Up solar tracker arrangement;

FIG. 2 is a partial perspective front end view of a wind break arrangement for a 2 Up solar tracker arrangement;

FIG. 3 is partial perspective rear end view of the wind break arrangement for a 2 Up solar tracker arrangement;

FIG. 4 is a side elevational view of the 2 Up solar tracker arrangement of FIG. 3;

FIG. 5 is a rear elevational view of the 2 Up solar tracker arrangement of FIG. 3;

FIG. 6 is a perspective view of an exemplary wind break end plate;

FIG. 7 is a plan view of the exemplary wind break end plate of FIG. 6; and

FIG. 8 is an enlarged cross-sectional view of the wind break end plate taken along lines 8-8 of FIG. 7.

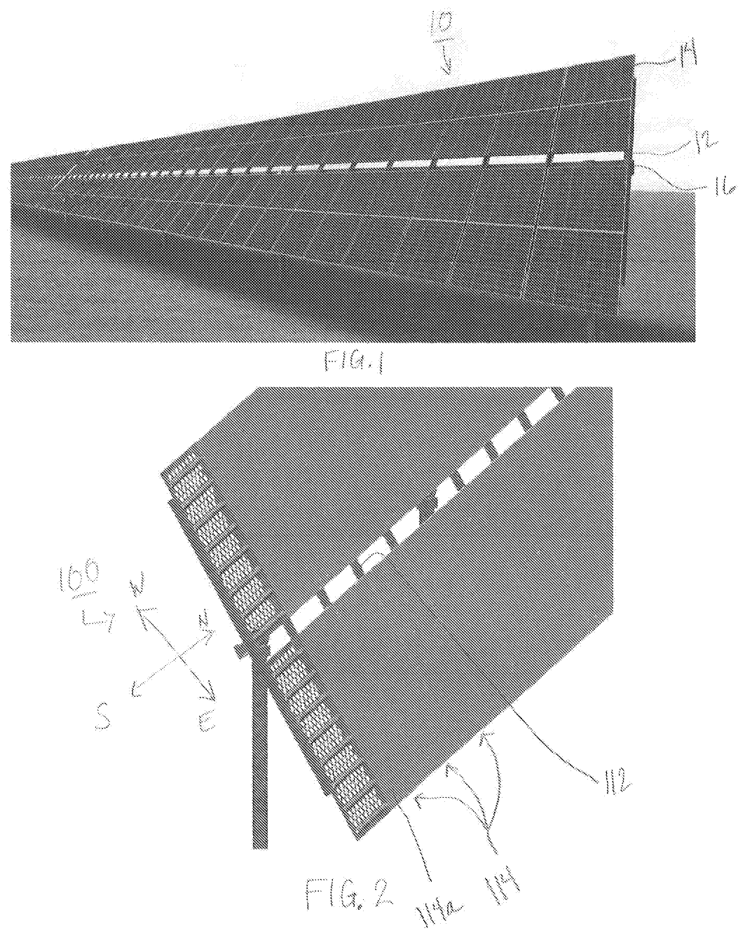

### DETAILED DESCRIPTION

Referring now to the discussion that follows and also to the drawings, illustrative approaches to the disclosed devices are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

While the below disclosure is described in connection with a 2 Up system 10, it is understood that the disclosure is not so limited. More specifically, the arrangements disclosed herein may be used other solar arrangements, including, but not limited to, 1 Up systems.

With reference to FIGS. 2-8, a solar tracker arrangement 100 is illustrated that addresses potential overstressing the arrangement 100 by applied wind loads during a design wind event. Similar to what is described above in connection with the typical 2 Up solar tracker arrangements 10, the solar tracker arrangement 100 includes a framework comprising a series of running rails 112 that extend along an east-west direction (i.e., in a first direction), when the solar tracker arrangement 100 is installed in an operational configuration. The axial extent of each set of east-west running rail set 112 defines the chord length CL of the of the solar-tracker arrangement 100 (see FIG. 4). The running rails 112 are spaced part a predetermined length and arranged to be parallel to one another. The length of the spacing between the running rails 112 is generally sized to correspond to the width of each PV module 114. In the arrangement shown, a PV module 114 is arranged between a pair of the adjacent running rails 112 in both the east direction and the west direction, along the length of the solar-tracker arrangement 100 to define an array of PV modules 114.

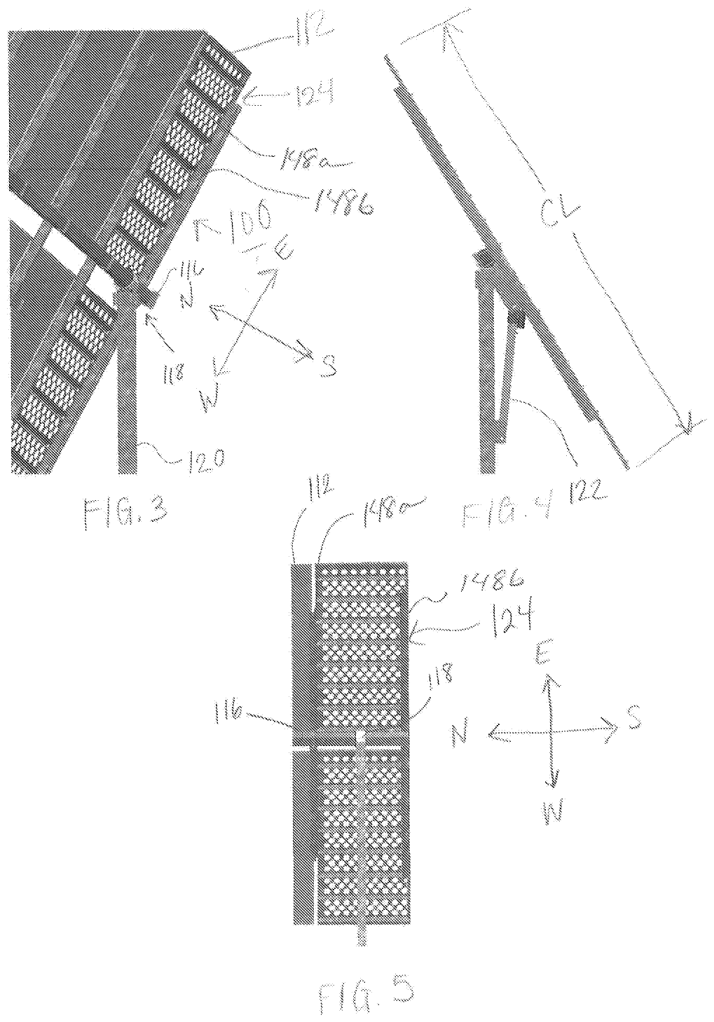

As may be seen best in FIG. 3, the running rails 112 are supported on either side of a torsion tube 116. The torsion tube 116 runs the length of the assembled solar tracker arrangement 100. The torsion tube 116 is oriented to extend in the north-south direction (i.e., in a second direction), when the solar tracker arrangement 100 is installed in an operational configuration. Thus the running rails 112 are generally perpendicular with the torsion tube 116.

The torsion tube 116 is supported by a bearing assembly 118 mounted to a fixed foundation member 120, such as a post. Actuators 122 serve to selectively tilt the solar tracker arrangement 100 to follow the sun.

Disposed along north and south edges of the array of PV modules 114 are wind break plates 124. In one exemplary arrangement, there is a set of two wind break plates 124, one disposed east of the torsion tube 116, and one disposed west of the torsion tube 116. In one exemplary arrangement, collectively, each set of the east-west wind break plates 124 have the same chord length CL as the PV modules 114. Alternatively, the east-west wind break plates 124 may have a different chord length than the PV modules 114. In the solar tracker arrangement 100, the torsion tube 116 extends beyond the northern and southern-most positioned running rails 114 so as to provide support for the wind break plates 124. In one exemplary arrangement, the torsion tube 116 is extended between 0.125× the chord length to 1.0× the chord length depending on the design wind event and the capacity of the PV modules.

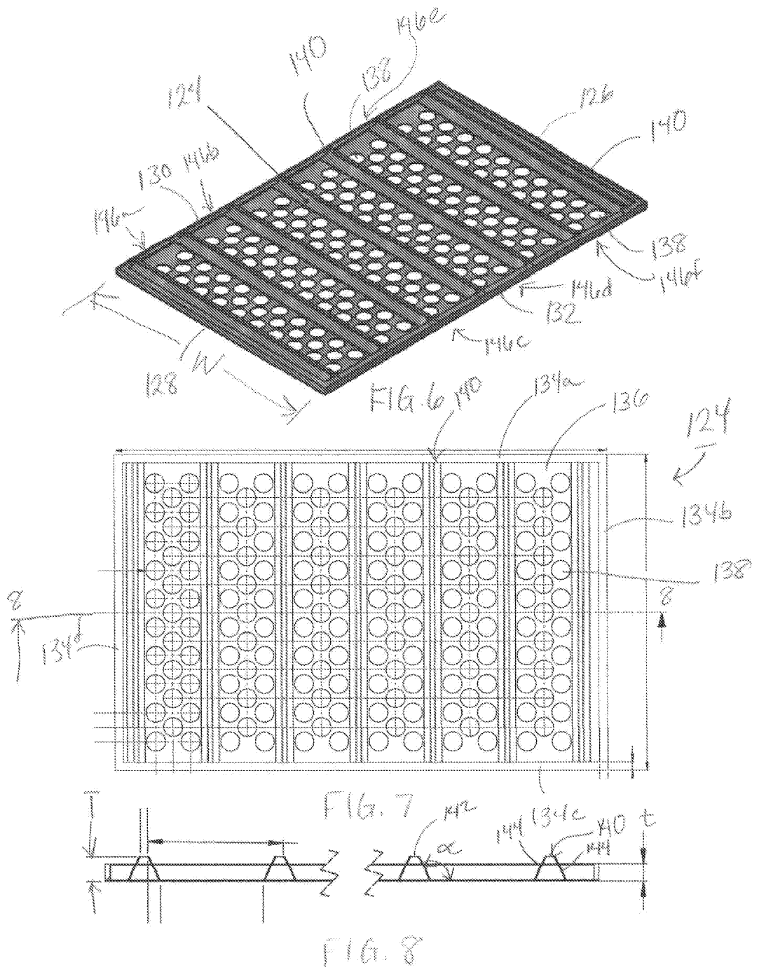

Referring to FIGS. 6-8, details of the exemplary wind break plate 124 will be described. Each of the wind break plates 124 is constructed of a material that is stronger than the PV modules 114, or is reinforced, such that the wind break plates 124 have a larger mechanical capacity than the PV modules 114. For example, the wind break plate 124 may be constructed of a material strong enough to support the maximum pressure the wind imparts to the solar tracker arrangement 100 during the design wind event. In one exemplary arrangement, the wind break plates 124 are constructed of galvanized steel. Alternatively, the wind break plates 124 could be constructed of corrugated metal. It is contemplated that other materials may also be employed. The wind break plates 124 can be opaque or clear. Clear material may serve to improve rear side energy harvest of bifacial PV modules 114.

Each wind break plate 124 is defined by top and bottom edges 126, 128, respectively, and parallel side edges 130, 132. The top, bottom and side edges 126, 128, 130, 132 collectively define the periphery of the wind break plate 124. In one exemplary arrangement, each edge 126, 128, 130, 132 of the wind break plate 124 may further include a support 134a-134d disposed about the periphery of the wind break plate 124, where the support surrounds a body section 136 therein. The body section 136 may have a thickness that is less than the thickness of the supports 134a-134d.

The width W of the wind break plate 124 is selected such that during a design wind event, the pressure the wind imparts to the PV module 114a (best seen in FIG. 2) that is positioned immediately inboard of the wind break plate 124 is below the mechanical capacity of the PV module 114. In other words, the wind load is reduced on the PV modules 114 on the north and south ends of the PV module 114 array.

In one exemplary arrangement, the body section 136 is solid (not shown), with no interruptions throughout its surface. In another exemplary arrangement, a series of individual upwardly extending stand-offs (not shown) may be formed in the body section 136, such as stamping. The stand-offs are configured to disrupt airflow and reduce wind pressures on the north and south edges of the PV array, while providing rigidity to the arrangement.

In yet another exemplary configuration, the body section 136 includes a series of perforations 138 formed through the body section 136. Unlike the alternative wind break plates 124 described, the perforations 138 allow some wind to pass through the wind break plate 124. Thus the perforations will prevent organized formation of vortexes on the leeward side of the wind break plate 124, thereby reducing the wind load on the PV module array 114.

Referring to FIGS. 6-7, in one exemplary arrangement, the perforations 138 are configured generally circular in shape and generally evenly spaced apart from one another. However, it is understood that the perforations 138 may have other shapes. The perforations 138 may be disposed in the range of approximately 30% to 80% of the surface area of the body section 136.

To prove a degree of rigidity to the wind break plate 124, a plurality of reinforcing elements 140 may be provided. In one exemplary configuration, the reinforcing elements 140 extend across the width W of the body section 136, between the side edges 130, 132, although other configurations are also contemplated. Referring to FIGS. 7 and 8, in one exemplary configuration, each reinforcing element 140 may be formed with a general trapezoid cross-section, defined by a top land surface 142 and side surfaces 144 that extend from the land surface 142 at an angle α with respect to the top surface of the body section 136. In one exemplary arrangement, the reinforcing elements 140 have a thickness T that is larger than a thickness t of the support members 134.

The reinforcing elements 140 may be spaced equidistance from each other to define different areas 146a-146f of the body surface 136. The areas 146a-146f may have an equal number of perforations 138 disposed therein, with each of the perforations 138 being spaced equidistant from each other, as illustrated in FIGS. 6 and 7.

Referring to FIG. 5, support rails 148a, 148b may be provided on either side of the wind break plate 124. The support rails 148a, 148b are secured to the torsion tube 116. Support rail 148a is also fixed to the outermost running rail 116 such that support rails 148a, 148b serve to connect the wind break plate 124 to the PV module 114 array. In one exemplary arrangement, the support rails 148a, 148b have a length that is less than the length of the running rails 112 to reduce weight to the system.

Because the wind break plate 124 takes up potential electrical generation space in the solar tracker arrangement 100, implementation of such an arrangement may be considered contrary to traditional solar panel design, which is typically dictated by maximizing real estate footprint, while meeting the requirements of a design wind event. However, the wind break plate 124 provides a significant advantage in having the maximum wind pressure on these system occur on the wind break plates 124 rather than the PV module 114, thereby reducing potential damage to the PV modules 114, particularly those located on the north and south ends of the solar tracker arrangement 100 where the highest wind pressures are experienced. Accordingly use of the large format PV modules, and particular in 2 Up configurations is viable, minimizing wind pressure damage on the ends PV modules 114. Moreover, the inclusion of perforations 138 further mitigates formation of organized vortexes on the leeward side of the wind break plate 124, thereby additionally reducing the maximum wind pressure applied to the solar tracking arrangement 100.

It will be appreciated that the solar tracker arrangement and the wind break plate and components described herein have broad applications. The foregoing embodiments were chosen and described in order to illustrate principles of the apparatuses as well as some practical applications. The preceding description enables others skilled in the art to utilize apparatuses in various embodiments with various modifications as are suited to the particular use contemplated. In accordance with the provisions of the patent statutes, the principles and modes of operation of this disclosure have been explained and illustrated in exemplary embodiments.

It is intended that the scope of the present methods and apparatuses be defined by the following claims. However, it must be understood that this invention may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. It is intended that the following claims define the scope of the invention and that the method and apparatus within the scope of these claims and their equivalents be covered thereby. In sum, it should be understood that the invention is capable of modification and variation and is limited only by the following claims.

1. A solar tracker arrangement, comprising:
a framework defined by running rails that extend in a first direction when in an operational configuration, the running rails arranged to be spaced apart and parallel to each other;
a plurality of PV modules mounted to the running rails to define a PV module array having a PV module cord length;
a torsion tube extending in a second direction when in an operational configuration, the running rails secured to the torsion tube such that rotation of the torsion tube tilts the PV modules in the first direction, where the first and second directions are substantially perpendicular; and
a wind break plate mounted to both a proximate edge and distal edge of the PV module array along the second direction and the torsion tube.

2. The solar tracker arrangement of claim 1, wherein the wind break plate is defined by a perforated body section.

3. The solar tracker arrangement of claim 2, wherein the wind break plate further includes one or more reinforcing members extending across the body section.

4. The solar tracker arrangement of claim 1, wherein the PV module array is arranged in a 2 UP configuration.

5. The solar tracker arrangement of claim 1, wherein the wind break plate has a chord length equal to the PV module array chord length.

6. A solar racking arrangement, comprising:
a framework defined by running rails that extend in a first direction when in an operational configuration, the running rails arranged to be spaced apart and parallel to each other;
a plurality of PV modules mounted to the running rails to define a PV module array having a PV module cord length;
a first wind break plate mounted to a proximate edge of the PV module array along a second direction substantially perpendicular to the first direction; and
a first wind break plate mounted to a distal edge of the PV module array along the second direction.

7. The solar racking arrangement of claim 6, wherein the first and second wind break plates each comprise a perforated body section.

8. The solar racking arrangement of claim 7, wherein the first and second wind break plates further include one or more reinforcing members extending across the perforated body section.

9. The solar racking arrangement of claim 6, wherein the PV module array is arranged in a 2 Up configuration.

10. The solar racking arrangement of claim 6, wherein at least one of the first and second wind break plates has a chord length equal to the PV module array chord length.

11. A wind break plate, comprising:
a body section bordered by support members; and
at least one reinforcing member extending between a pair of the support members;
wherein the body section includes a plurality of perforations therethrough.

12. The wind break plate of claim 11, wherein the perforations are formed in the range of 30% to 80% of a surface area of the body section.

13. The wind break plate of claim 11, wherein perforations are spaced equidistance from each other.

14. The wind break plate of claim 11, wherein the reinforcing members extends longitudinally between parallel side edges of the body section.

15. The wind break plate of claim 11, wherein the support members have a thickness that is greater than the thickness of the body portion.

16. The wind break plate of claim 15, wherein the reinforcing members have a thickness greater than the support members.
